(19) United States
(12) Patent Application Publication
(10) Pub. No.: US 2024/0010527 A1
(43) Pub. Date: Jan. 11, 2024

(54) WATER PURIFICATION AND DISINFECTION DEVICE

(71) Applicant: GUANGZHOU DEPOSON ELECTRIC TECHNOLOGY CO., LTD., Guangdong (CN)

(72) Inventors: Jianhua ZHONG, Guangdong (CN); Wenying ZHANG, Guangdong (CN); Yufu PAN, Guangdong (CN)

(73) Assignee: GUANGZHOU DEPOSON ELECTRIC TECHNOLOGY CO., LTD., Guangdong (CN)

(21) Appl. No.: 18/475,281

(22) Filed: Sep. 27, 2023

Related U.S. Application Data
(63) Continuation of application No. PCT/CN22/88887, filed on Apr. 25, 2022.

(30) Foreign Application Priority Data
Feb. 25, 2022 (CN) 202210180610.9

(51) Int. Cl. C02F 1/461; C02F 1/00; B01D 29/11; C02F 1/467

(52) U.S. Cl. CPC C02F 1/46104; C02F 1/001; B01D 29/114; C02F 1/467; C02F 2201/006; C02F 2303/04; B01D 2201/303; B01D 2201/347; C02F 2201/004; B01D 2201/4084; B01D 2201/4092; C02F 2201/46115; C02F 2201/46125

(57) ABSTRACT

A water purification and disinfection device is provided, including a cartridge cover, a filter cartridge, and an electrolytic unit. An inlet pipeline, an outlet pipeline, and an electrolytic unit fixing element are provided on the cartridge cover. The electrolytic unit fixing element has a mounting chamber, and a top of the electrolytic unit fixing element is provided with an electric connecting element. The filter cartridge is detachably connected to the cartridge cover, and the filter cartridge being provided with a to-be-filtered zone, a filtration core, and a filtered zone. The electrolytic unit is detachably mounted in the mounting chamber. A water inlet of the electrolytic unit is communicated with the filtered zone. A water outlet of the electrolytic unit is connected to the outlet pipeline, and an electric connecting pin of the electrolytic unit penetrates through the mounting chamber and is connected to the electric connecting element.

### CROSS-REFERENCE TO RELATED APPLICATION

This application is a continuation of international application of PCT application serial no. PCT/CN2022/088887 filed on Apr. 25, 2022, which claims the priority benefit of China application no. 202210180610.9 filed on Feb. 25, 2022. The entirety of each of the above mentioned patent applications is hereby incorporated by reference herein and made a part of this specification.

### BACKGROUND

### Technical Field

The present invention relates to the technical field of water purification and disinfection, and more particularly, to a water purification and disinfection device.

### Description of Related Art

Electrolytic units are widely used today to produce various chemical substances, such as compounds and elements. For example, electrolytic units typically produce ozone, which is an effective disinfectant for pathogens and bacteria, and therefore is an effective disinfectant. Many types of electrolytic units currently used generate ozone and dissolve it directly into water to remove pathogens and bacteria from the water. This reduces the need to directly dissolve disinfectant chemicals (such as chlorine) into unclean water.

Chinese patent application with a publication No. CN103874786A discloses an apparatus with a hub, the hub including a water inlet for receiving source water, a water outlet for discharging ozonated water, and an interface between the water inlet and the water outlet. The apparatus also has a cartridge including: an electrolytic cell for ozonating the source water, the electrolytic cell having a cathode, an anode comprising diamond, and a membrane between the cathode and the anode; a filter positioned to filter the source water before the source water enters the electrolytic cell; and at least one cartridge port for removably coupling with the interface on the hub, the at least one cartridge port configured to flow water from the hub into the electrolytic cell, and to flow ozonated water from the electrolytic cell into the hub. In this apparatus, the electrolytic cell and the filter are fixedly mounted inside the cartridge to form an integrated one. Therefore, users cannot remove one of them separately when it is necessary to replace/clean the electrolytic cell or the filter, and the cleaning after removal is troublesome, resulting in that users have to choose to replace the cartridge, the filtration core, and the electrolytic cell together, greatly increasing their usage costs. Moreover, when removing the cartridge, the pins and contact pads used for the electric connection of the electrolytic cell are prone to touch water droplets, especially at the contact pad where water droplets can easily flow in, leaving a hidden danger for reuse.

### SUMMARY

The purpose of the present invention is to provide a water purification and disinfection device to solve the problems proposed in the background technology.

The technical solution adopted to solve the above technical problems is as follows: a water purification and disinfection device, which includes:
a cartridge cover, an inlet pipeline, an outlet pipeline, and an electrolytic unit fixing element being provided on the cartridge cover, the electrolytic unit fixing element having a mounting chamber, and a top of the electrolytic unit fixing element is provided with an electric connecting element;
a filter cartridge, the filter cartridge being detachably connected to the cartridge cover, the filter cartridge being provided with a to-be-filtered zone, a filtration core, and a filtered zone, and the to-be-filtered zone being communicated with the inlet pipeline; and
an electrolytic unit, the electrolytic unit being detachably mounted in the mounting chamber, a sealing ring being provided between the electrolytic unit and the mounting chamber, a water inlet of the electrolytic unit being communicated with the filtered zone, a water outlet of the electrolytic unit being connected to the outlet pipeline, and an electric connecting pin of the electrolytic unit penetrating through the mounting chamber and being connected to the electric connecting element outside the mounting chamber.

Furthermore, the electrolytic unit includes a water inlet cover, a water outlet cover and at least one electrolytic assembly. An electrolytic chamber is formed between the water inlet cover and the water outlet cover, and the electrolytic assembly is located in the electrolytic chamber. The electrolytic assembly includes an electrode plate holder, and the electrode plate holder is sequentially provided with an anode plate, a proton-exchange membrane and a cathode plate from bottom to top. The water inlet and the water outlet of the electrolytic unit are respectively located on the water inlet cover and the water outlet cover.

Furthermore, the electrode plate holder is provided with an anode electric connecting slot and a cathode electric connecting slot. An anode electric connecting plate connected to the anode plate is fixed in the anode electric connecting slot and a cathode electric connecting plate connected to the cathode plate is fixed in the cathode electric connecting slot. The electrode plate holder is further provided with an anode electric connecting column and a cathode electric connecting column. The anode electric connecting column is connected to the anode electric connecting plate, and the cathode electric connecting column is connected to the cathode electric connecting plate. The anode electric connecting column and the cathode electric connecting column respectively penetrates through the water outlet cover and extends outward to form the electric connecting pins of the electrolytic unit.

Furthermore, the anode plate is a diamond anode plate, the cathode plate is a stainless-steel cathode plate, and a sealing pressing block for sealing and protecting the anode electric connecting plate and for pressing against the anode electric connecting plate is provided in the anode electric connecting slot. The cathode plate is integrally formed with the cathode electric connecting plate.

Furthermore, the electrolytic unit is fixed in the mounting chamber through threaded or snap-in connections.

Furthermore, the top of the electrolytic unit fixing element is provided with an arc-shaped hole which allows the electric connecting pin to pass through the arc-shaped hole, and the electric connecting pin rotates with the mounting or detachment of the electrolytic unit so as to contact or disconnect from the electric connecting element.

Furthermore, the water inlet cover is provided with a rotating handle.

Furthermore, the electric connecting element is a clip-on clamping elastic piece, and the clip-on clamping elastic piece is in clip-on connection with the electric connecting pin of the electrolytic unit.

Furthermore, the connection between the filter cartridge and the cartridge cover is threaded connection or snap-in connection.

Furthermore, the filter cartridge is cylindrical in shape, and both a bottom of the filter cartridge and a bottom of the electrolytic unit are provided with filtration core position limiting element.

Furthermore, the cartridge cover is further provided with a housing, and a power interface is provided on the housing. A control module is provided inside the housing, and the power interface is electrically connected to the control module.

Compared with the prior art, the technical solution of the present invention has the following advantages:

1. The filter cartridge and electrolytic unit of the present invention are detachably connected to the cartridge cover, so users can separately remove the filter cartridge or electrolytic unit to facilitate cleaning/replacing the filtration core or electrolytic unit, as well as cleaning the impurities filtered out in the filter cartridge. And it avoids being forced to replace both the filtration core and electrolytic unit at the same time, which avoids wasting, and also improves the reuse rate of the filtration core and electrolytic unit, greatly reducing usage costs for the user.

2. The sealing ring between the electrolytic unit and the mounting chamber ensures that the mounting chamber is a waterless chamber. At the same time, the electric connecting element is provided on the top of the electrolytic unit fixing element, such that the electric connecting pin extends out of the mounting chamber and is connected to the electric connecting element. This ensures that both the electric connecting pin and the electric connecting element are located in the waterless zone, so even when the electrolytic unit is removed, it is impossible to come into contact with water, thereby eliminating potential safety hazards.

### BRIEF DESCRIPTION OF THE DRAWINGS

In order to describe of the embodiments of the present invention or the technical solutions in the prior art more clearly, a brief introduction will be given to the accompanying drawings required in the description of the embodiments or prior art. It is evident that the accompanying drawings in the following description are only some embodiments of the present invention. For an ordinary skilled person in the art, other accompanying drawings can be obtained based on the structures shown in the accompanying drawings without any creative effort.

FIG. 1 is a schematic diagram of the three-dimensional structure of an embodiment of the present invention.

FIG. 2 is a schematic diagram of the internal structure of the embodiment of the present invention.

FIG. 3 is a structural schematic diagram of the cartridge cover in the embodiment of the present invention.

FIG. 4 is a schematic diagram of the three-dimensional structure of the electrolytic unit in the embodiment of the present invention.

FIG. 5 is a schematic diagram of the internal structure of the electrolytic unit in the embodiment of the present invention (three electrolytic assemblies).

The implementation, functional features, and advantages of the present invention will be further explained in conjunction with the embodiments, with reference to the accompanying drawings.

### DESCRIPTION OF THE EMBODIMENTS

The following will provide a clear and complete description of the technical solution in the embodiments of the present invention in conjunction with the accompanying drawings. Obviously, the described embodiments are only a part of the embodiments of the present invention, not all of them. Based on the embodiments in the present invention, all other embodiments obtained by an ordinary skilled person in the art without creative effort shall fall within the scope of protection of the present invention.

It should be noted that if there is a directional indication (such as up, down, left, right, front, back, etc) involved in the embodiments of the present invention, the directional indication is only used to explain the relative position relationship, motion situation, etc. between the components in a specific posture (as shown in the accompanying drawings). If the specific posture changes, the directional indication also changes accordingly.

### Embodiment 1

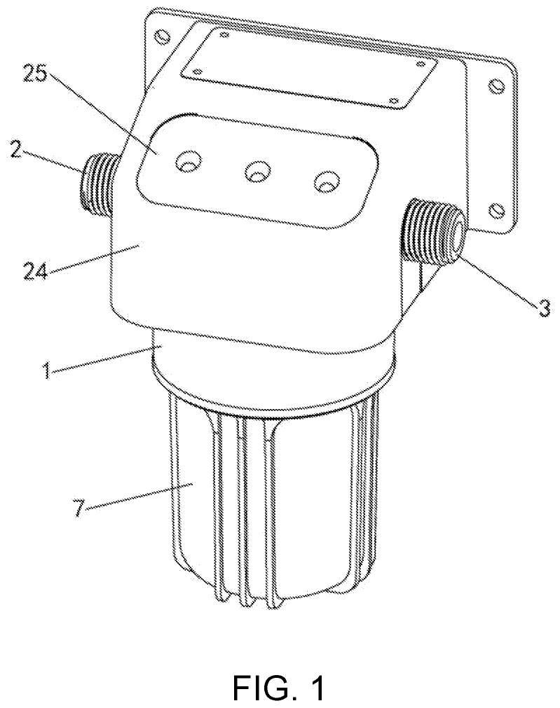

Referring to FIG. 1 to FIG. 5, a water purification and disinfection device in the present embodiment includes a cartridge cover 1, a filter cartridge 7, and an electrolytic unit 9, wherein the cartridge cover 1 is provided with an inlet pipeline 2, an outlet pipeline 3, and an electrolytic unit fixing element 4. The electrolytic unit fixing element 4 has a mounting chamber 5, and a top of the electrolytic unit fixing element 4 is provided with an electric connecting element 6; the filter cartridge 7 is detachably connected to cartridge cover 1. The filter cartridge 7 is provided with a to-be-filtered, a filtration core 8, and a filtered zone. The to-be-filtered zone is communicated with the inlet pipeline 2. The electrolytic unit 9 is detachably mounted in the mounting chamber 5. A sealing ring 10 is provided between the electrolytic unit 9 and the mounting chamber 5. The water inlet of the electrolytic unit 9 is communicated with the filtered zone. The water outlet of the electrolytic unit 9 is connected to the outlet pipeline 3, and the electric connecting pin 11 of the electrolytic unit 9 penetrates the mounting chamber 5 and is connected to the electric connecting element 6 outside the mounting chamber 5. In the present embodiment, the connection between filter cartridge 7 and cartridge cover 1 is threaded connection or snap-in connection, and a sealing ring 10 is provided at the connection between filter cartridge 7 and cartridge cover 1 to avoid water leakage. The electrolytic unit 9 is fixed in the mounting chamber 5 through threaded connection or snap-in connection.

The filter cartridge 7 and electrolytic unit 9 of the water purification and disinfection device are detachably connected to the cartridge cover 1 such that users can separately remove the filter cartridge 7 or electrolytic unit 9 to facilitate cleaning/replacing the filtration core 8 or electrolytic unit 9, as well as cleaning the impurities filtered out in the filter cartridge 7. And this avoids being forced to replace both the filtration core 8 and electrolytic unit 9 at the same time, which avoids wasting. Moreover, it further improves the reuse rate of the filtration core 8 and electrolytic unit 9, greatly reducing usage costs for users. In addition, the sealing ring 10 between the electrolytic unit 9 and the mounting chamber 5 ensures that the mounting chamber 5 is a waterless chamber, and meanwhile the electric connecting element 6 is provided on the top of the electrolytic unit fixing element 4, such that the electric connecting pin 11 extends out of the mounting chamber 5 and is connected to the electric connecting element 6. This ensures that both the electric connecting pin 11 and the electric connecting element 6 are located in the waterless zone, so even when the electrolytic unit 9 is removed, it is impossible to come into contact with water, thereby eliminating potential safety hazards when reuse. In addition, a sealing ring 10 is further mounted at the connection between the electrolytic unit 9 and the outlet pipeline 3 to prevent water from entering the mounting chamber 5 via said connection, further ensuring that the mounting chamber 5 is a waterless mounting chamber.

The filter cartridge 7 is preferably made of transparent material, which facilitates users to observe the degree of impurity accumulation and the degree of use of filtration core 8, such that users may determine whether it is necessary to clean filter cartridge 7 or replace filtration core 8.

The front end of the water purification and disinfection device uses a filtration core 8 for filtration, which can remove particulate matter from the water, while the back end uses an electrolytic unit 9 to produce a strong oxidizing disinfectant (such as ozonated water), ensuring that the back end can effectively perform sterilization and inhibit microbial growth. This not only solves the problem of secondary pollution at the back end of the traditional water purification device, but also enables the purified water to have disinfection and sterilization capabilities. The water purification and disinfection device in present embodiment has a wide range of application scenarios, and it can not only be used for daily water purification and disinfection in homes (for example, connecting it to a water pipe, using its generated disinfectant (such as ozonated water) to wash hands or fruits and vegetables, mounting it in front of the water inlet of the washing machine, and using its generated disinfectant (such as ozonated water) to disinfect clothes); and it can also be used for public health disinfection (for example, connecting it to the toilet flushing pipeline in public places (such as shopping malls, office buildings, etc.), and using its generated disinfectant (such as ozonated water) to disinfect urinals, squatting toilets, toilets, etc). The use of this water purification and disinfection device can effectively kill bacteria and inhibit the growth of microorganisms, with excellent results. In addition, the free ends of the inlet pipeline and the outlet pipeline of this water purification and disinfection device are both arranged to be threaded joints for easy mounting and use by users.

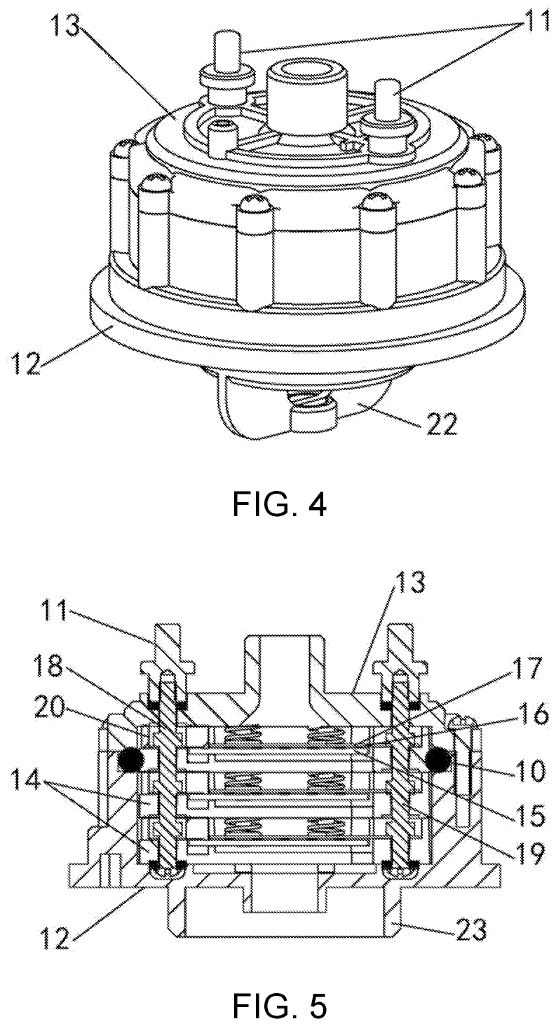

Referring to FIG. 4 and FIG. 5, in the present embodiment, the electrolytic unit 9 includes a water inlet cover 12, a water outlet cover 13, and at least one electrolytic assembly. An electrolytic chamber is formed between the water inlet cover 12 and the water outlet cover 13, and the electrolytic assembly is located in the electrolytic chamber. The electrolytic assembly includes an electrode plate holder 14, and the electrode plate holder 14 is sequentially provided with an anode plate 15, a proton-exchange membrane 16 and a cathode plate 17 from bottom to top. The water inlet and the water outlet of the electrolytic unit 9 are respectively located on the water inlet cover 12 and the water outlet cover 13, wherein the electrode plate holder 14, the anode plate 15, the proton-exchange membrane 16 and the cathode plate 17 are all provided with through holes for the passing of water. A sealing ring 10 is provided between the electrode plate holder 14 and the connection of the inlet cover 12 and the outlet cover 13 to avoid water existing in the electrolytic chamber and thereby preventing water entering into the mounting chamber 5 through the connection of the inlet cover 12 and outlet cover 13. In addition, an elastic component is provided between the cathode plate 17 and the electrode plate holder 14 or the water outlet cover located above cathode plate. Both ends of the elastic component respectively abut against an upper surface of the cathode plate 17 and a bottom of the electrode plate holder 14 or an inner wall of the water outlet cover 13. The elastic component may enable the cathode plate 17 to achieve elastic return after severe electrolytic reaction to ensure accurate and reliable position. Users can increase or decrease the number of electrolytic assemblies according to the application scenario, ensuring the use of the optimal concentration of disinfectant to avoid poor disinfection effect or wasting.

Specifically, the electrode plate holder 14 is provided with an anode electric connecting slot and a cathode electric connecting slot, wherein the anode electric connecting slot and the cathode electric connecting slot are respectively located on both sides of the electrode plate holder 14. An anode electric connecting plate connected to the anode plate 15 is fixed in the anode electric connecting slot, and a cathode electric connecting plate connected to the cathode plate 17 is fixed in the cathode electric connecting slot. The electrode plate holder 14 is further provided with an anode electric connecting column 18 and a cathode electric connecting column 19. The anode electric connecting column 18 is connected to the anode electric connecting plate, and the cathode electric connecting column 19 is connected to the cathode electric connecting plate. The anode electric connecting column 18 and cathode electric connecting column 19 penetrate through the water outlet cover 13 and extend outward to form electric connecting pins 11 of the electrolytic unit 9. The connection between the anode electric connecting column 18, cathode electric connecting column 19 and the water outlet cover 13 is provided with a sealing ring 10. Referring to FIG. 5, if there are two or more electrolytic assemblies, each electrolytic assembly is sequentially stacked, with all anode plates 15 sharing one anode electric connecting column 18 and all cathode plates 17 sharing one cathode electric connecting column 19. Preferably, the anode electric connecting column 18 and the cathode electric connecting column 19 are bolts, and both the anode electric connecting column 18 and the cathode electric connecting column 19 are provided with fixing nuts. Both the anode electric connecting plate and the cathode electric connecting plate are provided with openings. After the anode electric connecting column 18 and the cathode electric connecting column 19 passing through the openings, the fixing nuts fix the anode electric connecting plate and cathode electric connecting plate, ensuring good contact between the electric connecting plates and the electric connecting columns, and also ensuring fixation between various electrolytic assemblies.

As a preferred embodiment of the present invention, the anode plate 15 is a diamond anode plate, the cathode plate 17 is a stainless steel cathode plate, and the electrolytic unit is an ozone generator that generates ozone using a low-pressure electrolytic method. The ozone produced by electrolyzation of the electrolytic unit dissolves in water to form ozonated water with disinfection and sterilization capabilities, without producing toxic by-products. In addition, there are more efficient auxiliary components such as hydroxyl radicals and oxygen atoms, the overall disinfection and sterilization effect is more environmentally friendly and effective. Moreover, diamond anode plates and stainless steel cathode plates are less prone to loss during the electrolytic process, which can effectively improve the service life of the electrolytic unit. In addition, a sealing pressing block 20 for sealing and protecting the anode electric connecting plate and for pressing against the anode electric connecting plate is provided in the anode electric connecting slot. The sealing pressing block 20 can ensure good contact between the anode electric connecting plate and the anode plate 15, as well as isolation between the anode electric connecting plate and water, effectively ensuring the safety of the electrolytic process. The cathode plate 17 is integrally formed with the cathode electric connecting plate, which is not corroded by water and is easy to be produced and assembled.

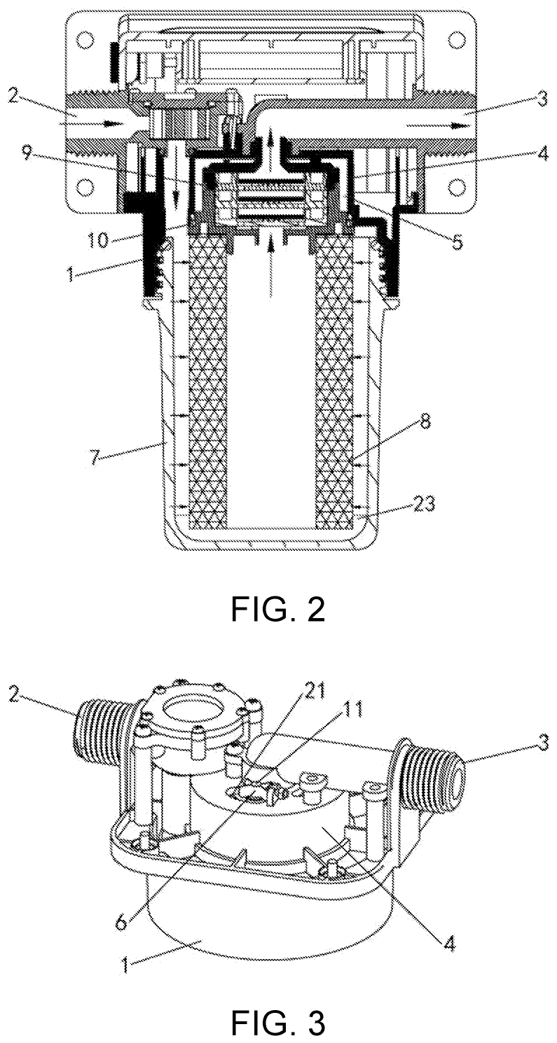

Referring to FIG. 3, as a preferred embodiment of the present invention, the top of the electrolytic unit fixing member 4 is provided with an arc-shaped hole 21 which allows the electric connecting pin 11 to pass through the arc-shaped hole. The electric connecting pin 11 rotates with the mounting or detachment of the electrolytic unit 9 to contact or disconnect from the electric connecting element 6, respectively. Preferably, the water inlet cover 12 is provided with a rotating handle 22, which helps users mount or remove the electrolytic unit 9 on their own.

Referring to FIG. 3, as a preferred embodiment of the present invention, the electric connecting element 6 is a clip clamping elastic piece, and the clip clamping elastic piece is in clip-on connection with the electric connecting pin 11 of the electrolytic unit 9. When the electric connecting pin 11 is mounted with electrolytic unit 9, the electric connecting pin 11 rotates and enters the clamping area of the clip-on clamping elastic piece, achieving close contact between the electric connecting pin 11 and the electric connecting element 6. When the electrolytic unit 9 is removed, the electric connecting pin 11 can also easily rotate away from the clamping area of the clip-on clamping elastic piece and disconnect from the electric connecting element 6.

Referring to FIG. 2, as a preferred embodiment of the present invention, the filtration core 8 is cylindrical in shape, and both the bottom of the filter cartridge 7 and the bottom of the electrolytic unit 9 are provided with a filtration core position limiting elements 23. The water enters the filtration core 8 from the to-be-filtered zone located on an outer side of filtration core 8 and is filtered, and then enters the filtered zone located on an inner side of filtration core 8. Then, it enters electrolytic unit 9 for electrolyzation to avoid impurities being in the water entering electrolytic unit 9, and impurities in the water entering electrolytic unit may cause blockage of the electrolytic unit and prevent it from working properly. The filtration core 8 is preferably at least one of carbon type filtration core, PP cotton type filtration core, sand type filtration core, ceramic type filter, and reverse osmosis (RO) type filtration core.

Referring to FIG. 1, as a preferred embodiment of the present invention, the cartridge cover 1 is further provided with a housing 24, which houses all components located on the cartridge cover 1 for protection. The free ends of the inlet pipeline 2 and outlet pipeline 3 extend out of the housing 24 in order for connecting pipes. The housing 24 is provided with a power interface in order for externally connected to a power supply, and a control module is provided inside the housing 24. The power interface is electrically connected to the control module, which provides transmission power and working signals for each component. Preferably, the housing 24 is provided with a display screen 25, and the display screen 25 is provided with a power signal light indicating the power-on status of the water purification and disinfection device, a work signal light indicating the working status of the water purification and disinfection device, and a maintenance signal light reminding users to maintain the filtration core 8 or electrolytic unit 9.

As a preferred embodiment of the present invention, a back side of the housing 24 is provided with heat dissipation holes and a heat sink, which can take away the heat generated by electrolysis of the electrolytic unit 9 and prevent the proton-exchange membrane 16 from being burned out due to excessive heat, which is beneficial for improving the service life of the electrolytic unit 9.

The above are only preferred embodiments of the present invention and do not limit its protection scope. Any equivalent structural changes made using the description and accompanying drawings of the present invention, or direct/indirect applications in other related technical fields, shall all be included in the scope of patent protection of the present invention.

What is claimed is:

1. A water purification and disinfection device, comprising:
a cartridge cover, wherein an inlet pipeline, an outlet pipeline, and an electrolytic unit fixing element are provided on the cartridge cover, the electrolytic unit fixing element has a mounting chamber, and a top of the electrolytic unit fixing element is provided with an electric connecting element;
a filter cartridge, wherein the filter cartridge is detachably connected to the cartridge cover, the filter cartridge is provided with a to-be-filtered zone, a filtration core, and a filtered zone, and the to-be-filtered zone is communicated with the inlet pipeline; and
an electrolytic unit, wherein the electrolytic unit is detachably mounted in the mounting chamber, a sealing ring is provided between the electrolytic unit and the mounting chamber, a water inlet of the electrolytic unit is communicated with the filtered zone, a water outlet of the electrolytic unit is connected to the outlet pipeline, and an electric connecting pin of the electrolytic unit penetrates through the mounting chamber and is connected to the electric connecting element outside the mounting chamber.

2. The water purification and disinfection device according to claim 1, wherein the electrolytic unit comprises a water inlet cover, a water outlet cover and at least one electrolytic assembly, an electrolytic chamber is formed between the water inlet cover and the water outlet cover, the electrolytic assembly is located in the electrolytic chamber, the electrolytic assembly comprises an electrode plate holder, the electrode plate holder is provided with an anode plate, a proton-exchange membrane and a cathode plate from bottom to top sequentially, and the water inlet and the water outlet of the electrolytic unit are respectively located on the water inlet cover and the water outlet cover.

3. The water purification and disinfection device according to claim 2, wherein the electrode plate holder is provided with an anode electric connecting slot and a cathode electric connecting slot, an anode electric connecting plate connected to the anode plate is fixed in the anode electric connecting slot, a cathode electric connecting plate connected to the cathode plate is fixed in the cathode electric connecting slot, and the electrode plate holder is further provided with an anode electric connecting column and a cathode electric connecting column, the anode electric connecting column is connected to the anode electric connecting plate, the cathode electric connecting column is connected to the cathode electric connecting plate, and the anode electric connecting column and the cathode electric connecting column respectively penetrate through the water outlet cover and extend outward to form the electric connecting pin of the electrolytic unit.

4. The water purification and disinfection device according to claim 3, wherein the anode plate is a diamond anode plate, the cathode plate is a stainless steel cathode plate, a sealing pressing block for sealing and protecting the anode electric connecting plate and for pressing against the anode electric connecting plate is provided in the anode electric connecting slot, and the cathode plate is integrally formed with the cathode electric connecting plate.

5. The water purification and disinfection device according to claim 2, wherein the electrolytic unit is fixed in the mounting chamber through threaded connection or snap-in connection.

6. The water purification and disinfection device according to claim 5, wherein the top of the electrolytic unit fixing element is provided with an arc-shaped hole which allows the electric connecting pin to pass through, and the electric connecting pin rotates with mounting or detachment of the electrolytic unit so as to contact or disconnect from the electric connecting element.

7. The water purification and disinfection device according to claim 5, wherein the inlet cover is provided with a rotating handle.

8. The water purification and disinfection device according to claim 1, wherein the electric connecting element is a clip-on clamping elastic piece, and the clip-on clamping elastic piece is in clip-on connection with the electric connecting pin of the electrolytic unit.

9. The water purification and disinfection device according to claim 1, wherein, a connection between the filter cartridge and the cartridge cover is threaded connection or snap-in connection.

10. The water purification and disinfection device according to claim 1, wherein, the filter cartridge is cylindrical in shape, and both a bottom of the filter cartridge and a bottom of the electrolytic unit are provided with filtration core position limiting elements.

11. The water purification and disinfection device according to claim 1, wherein the cartridge cover is further provided with a housing, a power interface is provided on the housing, a control module is provided inside the housing, and the power interface is electrically connected to the control module.

12. A water purification and disinfection device, comprising:
a cartridge cover, wherein an inlet pipeline and an outlet pipeline are provided on the cartridge cover;
a filter cartridge, wherein the filter cartridge is detachably connected to the cartridge cover, the filter cartridge is provided with a to-be-filtered zone, a filter, and a filtered zone, and the to-be-filtered zone is communicated with the inlet pipeline; and
an electrolytic unit, wherein a water inlet of the electrolytic unit is communicated with the filtered zone, a water outlet of the electrolytic unit is connected to the outlet pipeline, and the electrolytic unit is detachably connected to the cartridge cover.

13. The water purification and disinfection device according to claim 12, wherein the cartridge cover is provided with an electrolytic unit fixing element, the electrolytic unit fixing element has a mounting chamber, and the electrolytic unit is detachably mounted in the mounting chamber.

14. The water purification and disinfection device according to claim 13, wherein, a sealing ring is provided between the electrolytic unit and the mounting chamber.

15. The water purification and disinfection device according to claim 13, wherein a top of the electrolytic unit fixing element is provided with an electric connecting pin, and the electric connecting pin of the electrolytic unit penetrates through the mounting chamber and is connected to the electric connecting element outside the mounting chamber.

16. The water purification and disinfection device according to claim 13, wherein a filtration core is detachably mounted in the filter cartridge.

17. The water purification and disinfection device according to claim 16, wherein the filtration core is detachably connected to electrolytic unit.

18. The water purification and disinfection device according to claim 14, wherein a top of the electrolytic unit fixing element is provided with an electric connecting pin, and the electric connecting pin of the electrolytic unit penetrates through the mounting chamber and is connected to the electric connecting element outside the mounting chamber.

19. The water purification and disinfection device according to claim 14, wherein a filtration core is detachably mounted in the filter cartridge.

20. The water purification and disinfection device according to claim 19, wherein the filtration core is detachably connected to electrolytic unit.
